(19) United States
(12) Patent Application Publication
(10) Pub. No.: US 2025/0383638 A1
(43) Pub. Date: Dec. 18, 2025

(54) METHOD FOR CONTROLLING A SYSTEM, COMPRISING POST-PROCESSING OF A PREDICTIVE COMMAND

(71) Applicant: SAFRAN ELECTRONICS & DEFENSE, Paris (FR)

(72) Inventors: Maxime POUILLY-CATHELAIN, Moissy-Cramayel (FR); Olivier GALLAY, Moissy-Cramayel (FR); Dominique GIRARD, Moissy-Cramayel (FR); Nicolas DURET, Moissy-Cramayel (FR)

(73) Assignee: SAFRAN ELECTRONICS & DEFENSE, Paris (FR)

(21) Appl. No.: 18/832,758

(22) PCT Filed: Jan. 24, 2023
(86) PCT No.: PCT/FR2023/050096

§ 371 Date: Jan. 31, 2025

(30) Foreign Application Priority Data
Jan. 31, 2022 (FR) FR2200845

(51) Int. Cl. G05B 13/04; G05B 13/02

(52) U.S. Cl. CPC G05B 13/048; G05B 13/0265

(57) ABSTRACT

Method for monitoring a target system including the steps of obtaining input data relating to at least one current state of the target system, obtaining at least one functioning constraint of the target system, calculating, by a predictive control, an envisaged sequence of controls for monitoring the target system, from the input data, at least one target state of the target system, and the constraint; calculating, by a function readable by electronic equipment, a reliability value of the envisaged sequence of monitoring controls, according to at least one safety criterion, from the envisaged sequence of monitoring controls, and the constraint; generating, from the reliability value and a safety policy, at least one safety control; generating a monitoring control from the envisaged sequence of monitoring controls and the safety control, and applying this monitoring control to the target system.

### BACKGROUND OF THE INVENTION

The invention lies in the general field of the methods for monitoring a system. This system can be of any type. This could be, for example, a vehicle or an oven.

The invention is more particularly in the context of the monitoring methods using a predictive control.

A predictive control (MPC for Model Predictive Control) is a method for monitoring a system, which in particular allows the system to reach a certain target state of the system, while taking into account constraints to which this system is subject. In the present application, the “predictive control” will be designated by the initials “MPC”.

To this end, the MPC provides, at each calculation step, a set of controls for monitoring the system. Following the principle of the receding horizon, only the first control is applied to the system then the calculation is restarted iteratively. These controls are chosen in order to make the system evolve towards this target state.

In theory, the data calculated by the MPC obey the constraints. In practice, in particular because of calculation time limitations, the output data from the MPC may not obey the constraints, and have more or less significant gaps relative to the value that these output data should have if the MPC perfectly obeyed these constraints.

Some of these gaps have no significant consequences while others can lead to a failure or to an accident in the system.

In order to secure the functioning of the system, one solution may consist in shutting down the system as soon as such a gap is detected. But this solution may lead to a significant number of system shutdowns at the expense of its availability.

The present invention aims to increase the availability of a system monitored by an MPC.

### OBJECT AND SUMMARY OF THE INVENTION

To this end, and according to a first aspect, the invention concerns a method for monitoring a target system, this method including the steps of:
obtaining input data relating to at least one current state of the target system,
obtaining at least one functioning constraint of the target system,
calculating, by a predictive control, an envisaged sequence of controls for monitoring the target system, from said input data, at least one target state of said target system, and said constraint;
calculating, by a function readable by electronic equipment, a reliability value of said envisaged sequence of monitoring controls, according to at least one safety criterion, from said envisaged sequence of monitoring controls, and said at least one constraint;
generating, from said reliability value and a safety policy, at least one safety control; and
generating a monitoring control from said envisaged sequence of monitoring controls and said safety control, and applying this monitoring control to the target system.

Correlatively, the invention proposes a device for monitoring a target system including:
a module for obtaining input data relating to at least one current state of the target system,
a module for obtaining at least one functioning constraint of the target system,
a module for calculating, by a predictive control, an envisaged sequence of controls for monitoring the target system, from said input data, at least one target state of said target system, and said at least one constraint;
a module for calculating, by a function readable by electronic equipment, a reliability value of said envisaged sequence of monitoring controls, according to at least one safety criterion, from said envisaged sequence of monitoring controls, and said constraint;
a module for generating, from said reliability value and a safety policy, at least one safety control;
a module for generating a monitoring control from said envisaged sequence of monitoring controls and said safety control, and for applying this monitoring control to the target system.

Thus, and in general, the invention proposes a method for monitoring a target system, for example an oven whose state is characterized by the temperature of its different components or its contents, or a vehicle whose state is characterized by its speed and its position.

It can be considered that the monitoring method proposed by the invention includes two phases.

The first phase results in obtaining an envisaged sequence of monitoring controls so that the target system reaches one or several target state(s). These controls are calculated by the MPC from the target state and the input data, for example measurements of the current state of the target system. The MPC also takes into account one or several functioning constraints of the target system.

All or some of these constraints can in particular concern the state of the target system or some controls for monitoring this system.

For example, if the system is an oven, a safety policy can provide that some components do not exceed a temperature limit. In this case, a functioning constraint is the temperature limit of these components.

In another example in which the system is an autonomous car whose MPC monitors the steering, a safety policy can provide that the steering control does not change too abruptly to avoid causing the car to skid. In this case, the constraint is a limit on the change of steering of the car.

Despite the fact that the calculation performed by the MPC takes into account the functioning constraints of the target system, data calculated by the MPC do not systematically meet these constraints.

The sequence of controls determined by the MPC can correspond to a predicted behavior that does not meet the constraints. This is then referred to as gap between the constraints and the predicted quantity. This may or may not result in significant malfunctioning of the target system.

The evaluation of the impact of such a gap on the safety or on a subsequent malfunctioning of the target system is not easy in the general case.

Moreover, deciding to stop the functioning of the target system as soon as such a gap is noted can result in a significant number of unjustified shutdowns. This is not satisfactory with an objective of good availability of the target system.

To solve this problem, the present invention proposes to use, in a second phase of the monitoring method, a function readable by electronic equipment that performs a post-processing of the output data from the MPC.

Electronic equipment can for example designate a processor, a programmable logic circuit, an analog device, a computer, etc.

Thus, the second phase of the monitoring method determines, with this function, the reliability of the controls calculated by the MPC, from these controls, functioning constraints, safety criteria, and possibly any other data subject to the constraints, for example measurements of the state of the target system or predictions by the MPC of the state of the target system.

Also, an error corresponding to a gap between the data calculated by the MPC and the functioning constraints of the target system can be obtained and given as input to the function.

One example of calculating such an error is as follows. For an autonomous vehicle which is subject to the constraint of having its center of gravity located at an ordinate of at least one meter in a predefined reference frame, if the prediction of the future ordinate of the center of gravity of the vehicle is 0.99 meter, then the error is the difference between the minimum ordinate imposed by the constraint (one meter in this case) and the predicted ordinate (0.99 meter in this case), that is to say 0.01 meter.

The post-processing function provides a reliability value of the envisaged sequence of monitoring controls provided by the MPC. This value can for example correspond to a probability of occurrence of a future accident on the target system, or to a gap between a state of the system resulting from these controls and constraints on the system. The invention therefore makes it possible to improve the safety of the target system, but also to improve its availability, in particular relative to a monitoring method where the slightest gap relative to the constraints in the predictions of the MPC would lead to stopping the functioning of the target system.

After obtaining the reliability value, a safety control is generated according to a safety policy. For example, the safety control generated is a control to shut down the target system if the reliability value exceeds a threshold, or a control to extend the functioning of the target system if the reliability value is below this threshold.

After obtaining the envisaged sequence of monitoring controls by the MPC and the safety control, a monitoring control is generated and applied to the target system. This monitoring control is intended for the target system to reach the target state (or target states) provided that safety is met.

It should be specified that the fact that a monitoring control is intended to reach one or several target states does not mean that this/these target state(s) will necessarily be reached, but that the monitoring control makes the target system tend towards this/these target state(s)

In one embodiment of the monitoring method, if the safety control is to shut down the system, the monitoring control to be applied to the target system will also be to shut down the system.

In one embodiment of the monitoring method, if, in this same example, the safety control is to extend the functioning of the system, the monitoring control to be applied to the system will be identical to the first control of the envisaged sequence of monitoring controls.

The present invention therefore makes it possible to monitor a system with an MPC by taking into account a precise evaluation of the reliability of the controls calculated by the MPC, and thus provides the joint advantages of safety and availability of the system.

According to one mode of implementation of the invention, the safety control is a control to:
stop or not the functioning of said target system,
generate a data intended to improve a subsequent occurrence of the calculation step by said predictive control, by using this safety control as input to the predictive control, or
generate a data intended to improve a subsequent occurrence of the step of generating at least one safety control, by taking into account this data in the application of said safety policy.

The safety control can be intended to be used during the same iteration. In particular in the case where a future danger or malfunction is detected, the safety control may be a control for shutting down the system, as mentioned above.

The term iteration designates a completion of the set of steps of a method. In the embodiment of the monitoring method described here, this set comprises all the steps between obtaining the input data relating to at least one current state of the target system and applying the monitoring controls to the target system.

In another example, the safety control is a control to modify the MPC in order to prevent a malfunctioning of the target system. For example, if the target system is a car and the MPC calculates, from input data, an acceleration control that is too significant given the safety policy, the parameters of the MPC involved in the calculation of this acceleration control can be modified such that, for the same input data, the MPC calculates a lower acceleration control in line with this safety policy. Such a modification of the parameters can correspond to an increment of the values of the parameters responsible for the calculation of a too significant acceleration control. Such an increment can be the result of a gradient descent of the acceleration according to these parameters.

In another example, the safety control can be used again, in a subsequent occurrence of the safety control generation step, in particular during the application of the safety policy.

For example, the reliability value can be close to a threshold and thus indicate a potential danger or malfunction which does not require immediate shutdown of the target system. In this example, a first safety control indicating this potential malfunction is generated. Then, the monitoring control generated from this first safety control may not control the shutdown of the system.

In this same example, if in a subsequent step of generating a safety control, the reliability value is again close to the threshold, the safety policy takes into account the first safety control that was generated previously, so that a safety control to shut down the target system is generated this time.

In other words, in this example, a safety policy can, from two equal reliability values, generate two different safety controls, if one or several previously generated safety controls are, in one case, taken into account in the application of the safety policy, but are not taken into account in the other case.

Thus, according to one particular mode of implementation of the monitoring method, the step of generating the safety control includes the sub-steps of:
counting a number of safety controls previously generated and indicating a danger,
comparing this number with an additional threshold defined by the safety policy,
and the safety control is an emergency shutdown control to shut down the target system if the additional threshold is exceeded.

A reliability value or any other output of the post-processing function can also, in one particular mode of the invention, be reused during a subsequent iteration of the monitoring method, in particular during a subsequent occurrence of the step of calculating a reliability value.

Thus, in one mode of implementation of the monitoring method, the calculation, by the function of the reliability value, takes as input at least one data previously calculated by said function (F).

According to one particular mode of implementation of the monitoring method, said function belongs to at least one of the following categories:
an artificial neural network,
an implementation of a machine learning model,
an expert system.

The use of an artificial neural network can lead to a more efficient analysis of the data predicted by the MPC. In particular, since the data calculated by the MPC are in most cases in the form of sequences (in particular sequences of monitoring controls), the use of a convolutional neural network is advantageous.

The use of a neural network is also advantageous when the analysis of the data calculated by the MPC requires complex safety criteria. Such criteria cannot always be established by the user himself. Moreover, during its training, a neural network implicitly establishes such criteria, and can therefore provide a sufficiently fine analysis of the data calculated by the MPC.

In the same way, a function implementing a machine learning model (for example: logistic regression, support vector machine, decision trees) allows an evaluation of the data calculated by the MPC according to complex safety criteria.

In particular in the case where safety criteria can be established explicitly, for example by the user, it may be advantageous to use an expert system.

Given that an expert system includes explicit criteria, it easily makes it possible to explain the causes of obtaining a particular reliability value. For example, this makes it possible to explain which error in the controls calculated by the MPC requires the stop of the functioning of the target system.

According to one mode of implementation of the invention, the monitoring method includes a step of updating the function of calculating the reliability value.

In this embodiment, the invention thus proposes to adapt this function to the target system by optimizing the calculation of the reliability value by this function.

This is in particular advantageous in a case where the function has been determined from a system evolving in an environment different from that of the target system. This is for example the case if the target system evolves in a real environment, for example an autonomous car on a road, but if the function has been determined from a reference system evolving in a simulated environment, for example an autonomous car simulated on a computer.

An update of the function can also be beneficial when the user chooses it or when the environment imposes a change in constraints. An update then makes it possible to adapt the function to the new constraints.

An update of the parameters of the function can for example occur if the reliability value calculated by this function does not correspond to measurements of the state of the target system made subsequently to this calculation. For example, if the reliability value indicates that the controls calculated by the MPC are reliable, according to the safety policy, but the following measurements of the state of the target system do not obey the functioning constraints of this target system, the parameters of the function can be modified such that this scenario does not happen again. In other words, the parameters of the function are modified to prevent the reliability value of monitoring controls from being inconsistent with measurements of the state of the target system resulting from the application of these controls.

The update of the function can for example be done using a gradient descent technique, in particular if this function is a neural network.

In one embodiment of the monitoring method, the update of the function can also be performed by a user.

According to one particular mode of implementation of the monitoring method, said function is trained according to a reinforcement learning algorithm.

A reinforcement learning in particular makes it possible to take into account longer-term consequences of calculating the reliability value. In effect, a reinforcement learning is designed to teach the function to calculate a reliability value that maximizes the safety of the target system over several subsequent monitoring loops.

A reinforcement learning of the post-processing function can be carried out before the implementation of the target system monitoring method, and also during the implementation of the method.

According to a second aspect, the invention comprises a method for generating a function readable by electronic equipment and intended to calculate a reliability value of at least one envisaged sequence of controls for monitoring a target system, calculated by a predictive control, the method including the steps of:
obtaining at least one reference scenario associated with a reference system, said reference scenario including:
(i) at least one functioning constraint of the reference system,
(ii) at least one envisaged sequence of monitoring controls calculated by the predictive control from data relating to at least one state of the reference system, said at least one constraint and at least one target state of the reference system;
(iii) at least one target value characterizing a reliability of said at least one envisaged sequence of controls for monitoring this reference scenario;
   determining parameter values of said function to minimize at least one error between said at least one target value of the at least one reference scenario and at least one value calculated by said function from said at least one envisaged sequence of monitoring controls and said at least one constraint of this at least one reference scenario.
   recording, on a medium readable by electronic equipment, said function taking the parameter values obtained during the determination step.

Correlatively, the invention proposes a device for generating a function readable by electronic equipment and intended to calculate a reliability value of at least one envisaged sequence of controls for monitoring a target system, calculated by a predictive control, the method including:
a module for obtaining at least one reference scenario associated with a reference system, said reference scenario including:
(i) at least one functioning constraint of the reference system,
(ii) at least one envisaged sequence of monitoring controls calculated by the predictive control from data relating to at least one state of the reference system, said at least one constraint and at least one target state of the reference system;
(iii) at least one target value characterizing a reliability of said at least one envisaged sequence of monitoring controls of this reference scenario;
   a module for determining parameter values of said function to minimize at least one error between said at least one target value of the at least one reference scenario and at least one value calculated by said function from said at least one envisaged sequence of monitoring controls and said at least one constraint of this at least one reference scenario.
   a module for recording, on a medium readable by electronic equipment, said function taking the parameter values obtained by the determination module.

Generally, this method makes it possible to generate a function that will allow, thanks to the implementation of a monitoring method as described above, evaluating the reliability of data calculated by MPC for the monitoring of a target system.

For example, the invention in these two aspects can be used to monitor a production line of a factory.

Firstly, a reference system, for example the production line, is monitored by an MPC which takes into account constraints on the states of the line (for example: the products assembled along the line cannot occupy some positions under the risk of failure or accident of the reference system) and constraints on the controls calculated by the MPC (for example: a conveyor belt on which products circulate must not accelerate suddenly). Generally, these constraints are defined in relation to a safety policy.

Reference scenarios are then obtained during the functioning of the reference system. To do so, sequences of monitoring controls calculated by the MPC, functioning constraints of the reference system, and target values associated with each of these sequences of controls are recorded. For a given reference scenario, there is therefore a monitoring control or a sequence of monitoring controls associated with this scenario, as well as one or several associated constraints, and an associated target value.

A target value associated with a reference scenario within the meaning of the invention is a value characterizing the monitoring control or the monitoring sequence associated with this reference scenario. Particularly, this target value corresponds to an objective reliability value of the monitoring controls calculated by the MPC associated with this reference scenario.

For example, such a target value indicates whether or not the sequence of controls with which it is associated led or not to a significant malfunction of the production line, according to a safety policy.

Secondly, a function is generated from these reference scenarios, in accordance with the generation method of the invention.

Thus, the values of the parameters of the function are adapted such that the function calculates, from a sequence of monitoring controls and an associated constraint, a value which is identical to or as close as possible to the target value associated with this sequence. In the present example, the values of the parameters of the function are adapted so as to predict a significant malfunctioning or a proper functioning of the production line monitored by the MPC, the proper functioning being defined in relation to a safety policy. For example, this policy qualifies as dysfunctional any state of the production line in which the production can no longer be ensured, and as functional otherwise.

In general, the step of determining the values of the parameters of the function can be carried out in different ways depending on the nature of the function. If this function is a neural network or an implementation of a machine learning model, the determination step corresponds to a training of this function. In the case of an expert system, the determination step can correspond to a calibration of the values of the parameters of this expert system.

For example, if the function is a neural network, it can be trained by a gradient descent method. In this case, the training includes several iterations in each of which the function calculates values from reference scenarios previously obtained. An error, often used as a cost function in the case of a gradient descent method, is then calculated. This error corresponds to a gap, for each reference scenario, between the value calculated by the artificial intelligence from this scenario and the target value associated with this scenario.

This error (or cost function) then makes it possible to apply the gradient descent algorithm on the parameters of the neural network [A reference on the gradient descent is “An overview of gradient descent optimization algorithms”, by Sebastian Ruder, arXiv: 1609.04747, 2017].

Once the values of the parameters of the functions have been adapted, the function is recorded with these parameter values, to be able to be used in a target system monitoring method as described above.

In the present example, the determined and recorded function can be used for the predictive control which monitors the production line.

In a case where the recording of real scenarios is considered too dangerous or too costly, for example in the case of monitoring an autonomous car, the invention proposes the possibility of simulating reference scenarios.

Thus, according to one mode of implementation of the generation method, said at least one reference scenario is simulated by computer. In such embodiment, a virtual model representing the characteristics of a target system is constructed, this virtual model constituting a reference system. Once this reference system has been obtained, it is possible to implement the generation training method as described previously.

It is noted that in such a case, the MPC must be integrated into the simulation of reference scenarios so that the monitoring controls it calculates act in a similar way on the virtual reference system and on the target system in the real world.

In another embodiment, the reference scenario is simulated from physical models of the reference system and its environment representing the target system and its environment.

According to one mode of implementation of the monitoring method, the function is generated according to one of the modes of implementation of the generation method as described above.

The invention also proposes a system comprising:
a control apparatus including at least one monitoring device as described above; and
computing equipment including a generation device as described above.

This system can for example be a vehicle or a system remotely connected to a vehicle, making it possible to monitor this vehicle and/or to set up a generation method in accordance with the invention, by recovering the data on this vehicle.

In one embodiment of the invention, the generation device is a computer able to communicate these values to a control apparatus including a monitoring device in accordance with the invention.

In another embodiment of the invention, the monitoring device is integrated into a control apparatus. Such equipment can in particular obtain a function provided by a third party.

The invention proposes a computer program including instructions for the execution of the steps of a monitoring method according to any one of the implementation modes described above.

The invention also proposes a computer program including instructions for the execution of the steps of a generation method according to any one of the modes of implementation described above.

It should be noted that the computer programs mentioned in the present disclosure can use any programming language, and be in the form of source code, object code, or intermediate code between source code and object code, such as in partially compiled form, or in any other desirable form.

The invention proposes a medium, readable by computing equipment and/or a control apparatus, for recording a computer program including instructions for the execution of the steps of a monitoring method according to any of the embodiments described above.

The invention also proposes a medium readable by computing equipment and/or a control apparatus, for recording a computer program including instructions for the execution of the steps of a generation method according to any of the embodiments described above.

The recording media mentioned in the present disclosure may be any entity or device capable of storing the program and of being read by a control apparatus or by any computing equipment, in particular a computer.

For example, the medium can include a storage means, or a magnetic recording means, for example a hard disk.

Alternatively, the recording media can correspond to a circuit integrated into a computer or into a control apparatus, circuit in which the program is incorporated, and adapted to execute a method as described above or to be used in the execution of this method.

### BRIEF DESCRIPTION OF THE FIGURES

FIG. 1 represents a method for generating a function in accordance with one particular mode of implementation of the invention.

FIG. 2 represents a device for generating a function in accordance with one particular mode of implementation of the invention.

FIG. 3 represents a method for monitoring a target system in accordance with one particular mode of implementation of the invention.

FIG. 4 represents the essential elements of a reinforcement learning of the function in accordance with one particular mode of implementation of the invention.

FIG. 5 represents a device for monitoring a target system in accordance with one particular mode of implementation of the invention.

FIG. 6 represents a system in accordance with one particular mode of implementation of the invention.

FIG. 7 represents the hardware architecture of a generation device according to one particular mode of implementation of the invention.

FIG. 8 represents the hardware architecture of a monitoring device according to one particular mode of implementation of the invention.

### DETAILED DESCRIPTION

Several embodiments of the invention will now be described. Generally, and as mentioned previously, the invention proposes a method for generating a function F that can be used to evaluate the reliability of monitoring controls CCE calculated by an MPC for a target system, as well as a method for monitoring a target system using such a function.

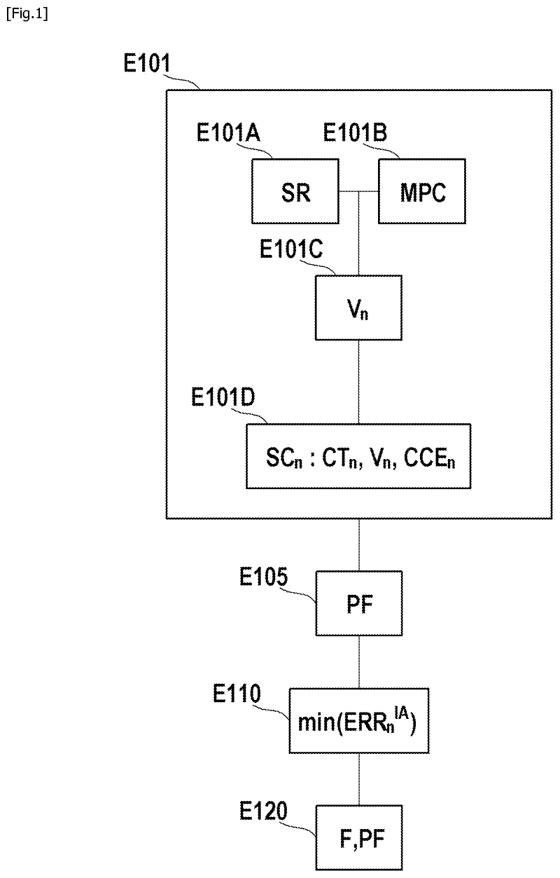

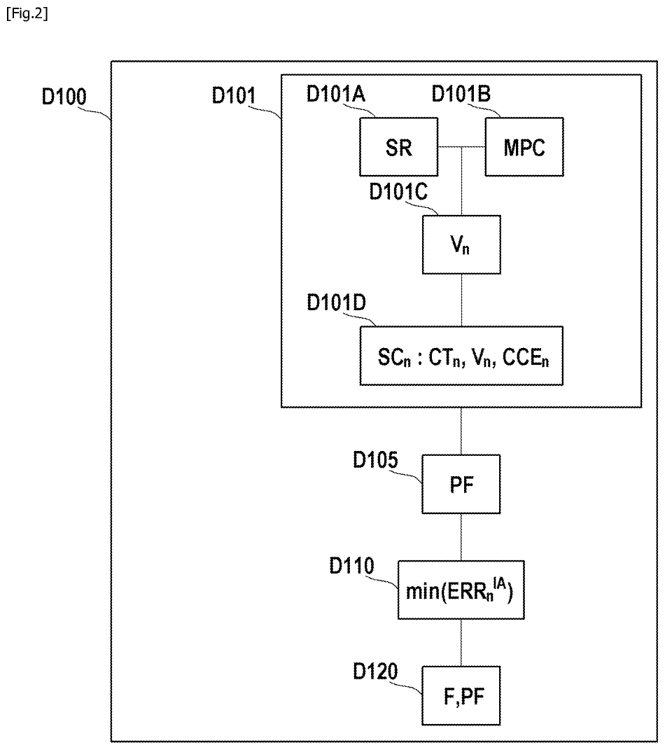

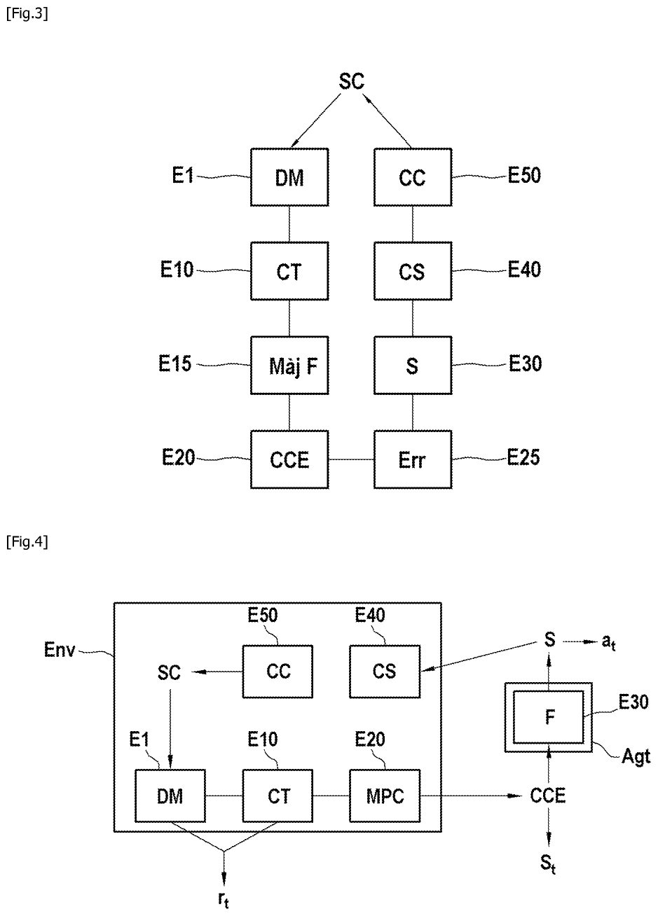

With reference to FIGS. 1 and 2, the generation method will be described, and with reference to FIGS. 3 and 4, the method for monitoring a target system SC with this function F will be described.

FIG. 1 represents the main steps of a method for generating the function F intended to evaluate the reliability of the monitoring controls calculated by an MPC monitoring a target system in accordance with one particular embodiment of the invention.

The generation of the function F is based on a set of at least one reference scenario SCR relating to a reference system SR monitored by an MPC, under some functioning constraints CTₙ of the reference system SR. it is noted that these constraints CTₙ can be identical for all the reference scenarios.

Thus in the embodiment described here, the generation method includes a step E101 of obtaining reference scenarios SCR, itself composed of several sub-steps (E101A, E101B, E101C, E101D).

Substep E101A applies, to the reference system SR, the first control of the envisaged sequence of monitoring controls CCEₙ calculated by the MPC in step E101B, and measures the state of the reference system SR resulting from the application of this control.

It is noted that the application of the first control of the sequence of controls CCEₙ calculated by the MPC is not a limiting characteristic of the invention. For example, in another embodiment, the X first controls of the sequence of controls CCEₙ calculated by the MPC are applied successively to the reference system SR, X being a predefined number.

It is noted that the reference system SR can be virtual. In this case, a simulation is performed during step E101A to simulate the evolution of the reference system.

The state measurement of the reference system SR performed in step E101A is then taken as input data for the MPC in step E101B. Step E101B of calculation by the MPC can then be performed again, from this measurement and the constraints CTₙ. These two steps (E101A, E101B) can thus be repeated in a loop to obtain a set of envisaged sequences of controls CCEₙ calculated by the MPC.

The end of a sequence can be decided according to different criteria, for example when a number of repetitions of steps E101A and E101B is reached.

In another embodiment, a single iteration of steps E101A and E101B is performed: a measurement of the state of the reference system SR is performed in step E101A then transmitted to the MPC which calculates a monitoring control in step E101B.

Subsequently, one embodiment is considered in which a reference scenario is characterized by a set of sequences of controls CCEₙ. This is not limiting for the present invention, and does not prohibit the case where a single sequence of controls CCEₙ is associated with a reference scenario.

Step E101C respectively assigns a target value Vₙ to each sequence of controls CCEₙ thus produced, following a safety policy. In a case where the function F is intended to predict whether the application of the sequence of controls CCEₙ calculated by the MPC leads to a malfunctioning, according to this safety policy, of the reference system SR, this target value Vₙ is for example chosen equal to 1 if the application of this sequence of controls CCEₙ results in an unwanted shutdown of the reference system SR (the value 1 then corresponds to a dysfunctional sequence of controls CCEₙ) and 0 if it does not result in a shutdown of the system (the value 0 then corresponds to a reliable sequence of controls CCEₙ).

In another embodiment, the target value Vₙ can be determined from the constraints CTₙ by comparing the state of the reference system and these constraints CTₙ.

For example, if the state of the reference system SR resulting from the application of an envisaged monitoring control CCEₙ does not obey the constraints CTₙ, the target value Vₙ is chosen equal to 1, and to 0 otherwise.

In another example, the target value Vₙ can also be chosen equal to an error between this state of the reference system and the constraints CTₙ.

In another example, the state of the reference system which is compared to the constraints CTₙ to obtain the target value Vₙ is a state predicted by the MPC in conjunction with the calculation of the envisaged sequence of controls CCEₙ.

For a set of produced sequences of controls CCEₙ, a step E101D records this set as well as the target values Vₙ and the constraints CTₙ associated, to produce a reference scenario SCR.

A set of several reference scenarios can be produced by the repetition of substeps E101A, E101B, E101C and E101D as described above.

During a step E105, a function F and initial values of its parameters PF are obtained.

In one embodiment where the function F is an artificial neural network, the values of its parameters PF designate the values assigned to each neuron, and are for example chosen randomly following a probability distribution (for example a normal or a uniform law).

In another embodiment where the function F is an expert system, the initial values of the parameters PF are for example chosen according to a heuristic. For example, it may be known that some particular values of monitoring controls often lead to malfunctions or accidents, which can be integrated into the expert system. Optionally, part of the initial values of the parameters of the expert system can be chosen randomly.

During a step E110, the values of the parameters PF of this function F are determined so as to minimize errors Errₙ^{IA}, each of these errors corresponding to a gap between the target values Vₙ associated with the reference scenario SCR and values calculated by the function F respectively from each envisaged sequence of controls CCEₙ of this reference scenario SCR.

The error Errₙ^{IA} can take different forms, for example the module of a difference between a target value Vₙ and a value calculated by the function F, or the square of such a difference, or a cross-entropy obtained from these two values. These examples are not exhaustive and in no way constitute a limitation of the invention.

In the case where the function is an artificial neural network or an implementation of a machine learning model, the step E110 of determining the values of the parameters corresponds to a learning or training step.

In this case, the training of the function can be done in several gradient descent steps. At each step, new values Errₙ^{IA} are calculated and the values of the parameters of the function are updated with a gradient descent from these errors Errₙ^{IA}. The training can in particular be finished when a sufficiently low average of the error Errₙ^{IA} is reached.

Once the errors Errₙ^{IA} have been minimized, a step E120 records the function F with the values of the parameters PF obtained during step E110, for example on a hard disk, a server, or any medium readable by electronic equipment.

FIG. 2 represents a generation device D100 in accordance with one particular mode of the invention for preparing a function F.

The device D100 includes a module D101 for performing reference scenarios.

This module D100 includes four sub-modules (D101A, D101, D101C, D101D).

The submodule D101B performs the calculation by an MPC of an envisaged sequence of controls for monitoring CCEₙ a reference system SR, from constraints CTₙ. These monitoring controls CCEₙ are provided to the module D101A, which applies at least the first of these controls CCEₙ to the reference system SR and measures the resulting state of this system SR.

The two submodules D101A and D101B can perform these steps once, or several times in order to construct a set of sequences of controls CCEₙ calculated by the MPC.

Each sequence of controls CCEₙ is provided to the submodule D101C which associates it with a target value Vₙ.

The submodule D101D records the data CTₙ, Vₙ, and CCEₙ obtained by the submodules D101A, D101B and D101C, to constitute a reference scenario SCR.

These submodules can repeat these steps several times so as to construct a set of reference scenarios.

The device D100 also comprises a module D105 for initializing the values of the parameters PF of a function F.

The device D100 includes a module D110 for determining the values of the parameters PF of the function F from the reference scenario(s) SCR constructed by the module D101.

The device D100 includes a module D120 for recording the function F and the values of its parameters PF obtained by the module D110, for example on a hard disk, a server, or any medium readable by electronic equipment.

FIG. 3 represents one particular mode of implementation of a method for monitoring a target system SC in accordance with one particular embodiment of the invention.

The method of FIG. 3 includes a step E1 of obtaining input data DM for the MPC, these data DM relating to at least one state of the target system SC. In this particular mode of implementation, these input data DM are measurements of the state of the target system. These measurements DM can be performed by sensors on the target system SC.

In another embodiment, a state of the target system SC can be deduced from the input data DM via their analysis by a user or an observer. For example, it is possible to use the current and voltage measurements of a motor and deduce the state of the system therefrom. One example of a state thus deduced is the set of the following values: position, speed, current, and voltage.

During a step E10, constraints CT relating to the target system are obtained. In this embodiment, these constraints CT characterize limits on the state of the target system SC so that it does not experience a malfunction or accident defined according to a safety policy.

In another embodiment, these constraints CT are restrictions on the monitoring controls that can be applied to the target system.

In another embodiment, the constraints CT concern both limits on the states of the target system SC and limits on the monitoring control.

In other embodiments, the constraints may be a function of the states and controls.

During a step E20, the MPC calculates, from the input data DM, constraints CT, and from a target state, an envisaged sequence of monitoring controls CCE, the first of which is intended to be applied to the target system SC in order to reach this target state.

In the particular embodiment represented in FIG. 3, the monitoring method also comprises a step E25 of calculating errors Err of this sequence of controls CCE relative to the constraints CT. These errors will also be given as input to the function F during the following step E30.

During step E30, a function F calculates a reliability value S from the sequence of controls CCE, the constraints CT and the errors Err.

In another embodiment in which step E25 is not present, the calculation of S by the function F takes as input the envisaged monitoring control CCE and the constraints CT.

In another embodiment, the function F takes as input, in addition to the sequences of controls CCE and to the constraints CT, reliability values calculated during previous iterations of the monitoring method. In this embodiment, the reliability value S calculated in step E30 is recorded to be used as input to the function F during subsequent iterations of the monitoring method.

This value S characterizes a reliability of the envisaged sequence of monitoring controls CCE calculated by the MPC. In this particular embodiment, high reliability of this control CCE corresponds to the prediction of a proper functioning of the target system following the application of this sequence of controls CCE to the target system SC, while a low quality corresponds to the prediction of a malfunctioning of the target system SC following the application of this control CCE.

In another embodiment, this reliability value can quantify a potential danger or risk of accident if the sequence of controls CCE were applied to the target system.

The reliability value S calculated in step E30 is used in a step E40 of generating a safety control CS from a safety policy.

For example, this safety policy can correspond to the comparison of the value S with a threshold. Depending on the result of a comparison of the value S with the threshold, this safety policy indicates the safety control CS to be generated accordingly.

In the embodiment represented in FIG. 3, this safety control is a control to shut down or a control to extend the functioning of the target system SC. If the reliability value S indicates low reliability of the envisaged monitoring control CCE, according to the safety policy, the safety control CS is the shutdown of the target system SC. Conversely, if S indicates high reliability, the safety control CS is the extension of the functioning of the target system SC.

In another example, this safety control can indicate a potential danger to the target system according to the safety policy, but an extension of the functioning of the target system SC. This safety control indicating a danger will be used in one or several subsequent iterations of the monitoring method, in accordance with one of the modes of implementation of the invention. Thus, in this example, at each iteration of step E40 of the monitoring method, a number of safety controls which have been generated that indicate a potential danger are counted and this number is compared to an additional threshold. If the number exceeds this additional threshold, a safety control indicating the emergency shutdown of the target system is generated.

In another embodiment, the safety control CS can be the replacement of the predictive control by another monitoring algorithm (for example less efficient but safer).

A less efficient but safer example of control is the “min-max predictive control”. It consists in minimizing the trajectory error at each moment by assuming that the “worst” case always occurs.

In another embodiment, the safety control CS is an emergency maneuver control different from an emergency shutdown. For example, in the case of the monitoring of an autonomous or semi-autonomous vehicle, an emergency maneuver may be the maximum steering requested immediately.

In the case of a semi-autonomous system, the safety control CS can for example correspond to returning the monitoring to the user.

A step E50 generates then applies to the target system SC a monitoring control CC from the envisaged monitoring control CCE and the safety control CS obtained during the previous steps.

In one particular mode of implementation of the invention in which the safety control CS is either a control to shut down or a control to extend the functioning of the target system SC, the monitoring control CC applied to the target system SC is:
either identical to the envisaged monitoring control CCE if the safety control CS is an extension of the functioning of the target system SC,
or a control to shut down the target system if the safety control CS is the shutdown of the target system SC.

In the case where the functioning of the system is extended, the new state reached by the target system following the application of the monitoring control CC in step E50 is measured in step E1.

Thus, these measurements begin a new iteration of the monitoring loop defined by steps E1 to E50 as described previously.

In the particular mode of implementation represented in FIG. 3, the monitoring method comprises a step E15 of updating the function F. This update can be implemented from the second iteration of the monitoring loop, after obtaining the data DM relating to the target system SC.

This update consists in modifying the values of the parameters of the function F so as to improve the evaluation of the reliability of the envisaged sequence of monitoring controls CCE.

In one particular mode of implementation, the update is performed E15 from an error, for example with a gradient descent technique. This error can be generated from the last reliability value calculated by the function F and input data DM obtained in step E1.

For example, if this last reliability value indicates proper functioning of the system according to a safety policy, but if the measurement of the state of the system indicates a malfunction according to this same policy, then the error is high and induces a significant change of the parameter values PF of the function F.

FIG. 4 represents the essential elements for setting up a reinforcement learning of the function F, in accordance with one particular embodiment of the invention.

In this example, the essential elements of the reinforcement learning algorithm (namely an agent Agt, an environment Env, states sₜ, actions at and rewards rₜ) are organized as follows:
a state sₜ comprises at least the envisaged sequence of monitoring controls CCE calculated by the MPC;
the agent Agt comprises the function F;
an action aₜ is predicted by the agent Agt from the state sₜ, which corresponds to the calculation of a reliability value S by the function F;
the environment Env comprises steps E40 and E50 of generating safety and monitoring controls from a reliability value S, the target system SC, the data DM relating to the target system SC, and the MPC;
a reward rₜ is obtained from the data DM.

The effect of the action at on the environment Env corresponds to the following steps:
steps E40 and E50 which lead to the application of a monitoring control CC to the target system SC;
the evolution of this system SC following the application of the monitoring control CC;
step of obtaining E1 the data DM relating to this system SC following its evolution;
step of obtaining E10 constraints CT relating to the system SC;
the calculation E20 by the MPC of a new envisaged sequence of controls, corresponding to a new state Sₜ₊₁.

In this example, the reward rₜ can be negative (for example equal to −1) if the data DM do not obey the constraints CT, or zero otherwise.

The objective of the reinforcement learning is to maximize an average of rewards r₁-r_{T} obtained over several iterations of the steps going from obtaining an action at by the agent until obtaining a new state Sₜ₊₁.

Many reinforcement learning algorithms can be applied to achieve this objective. Those skilled in the art can refer to a reference work such as

[“Reinforcement Learning, An Introduction”, Second Edition, Richard S. Sutton and Andrew G. Barto, MIT Press, 2018] for the presentation of such algorithms as well as of their practical implementation.

In another embodiment of the invention, the reinforcement learning of the function F is done before the implementation of the target system SC monitoring method.

Such learning can be performed with a reference system similar to the target system. In particular, this reference system can be a simulation of the target system.

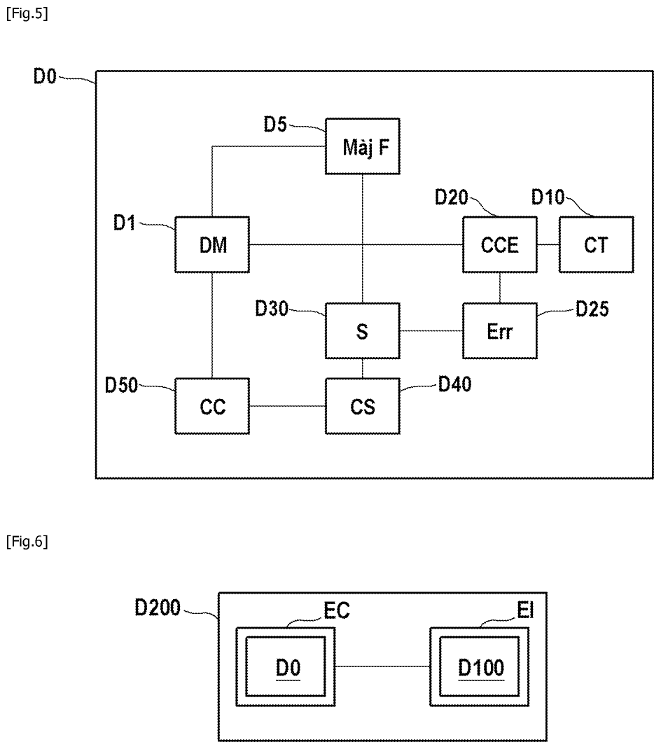

FIG. 5 represents a monitoring device D0 of a target system in accordance with one particular embodiment of the invention.

The device D0 includes a module D1 for obtaining input data DM relating to the target system as well as a module D10 for obtaining constraints CT relating to this target system.

In this particular embodiment, the input data DM are measurements of the state of the target system.

A module D20 uses the input data DM and the constraints CT to perform the calculation, by an MPC, of an envisaged control for monitoring CCE the target system SC.

In this particular embodiment, a module D25 calculates an error Err of the envisaged monitoring control CCE relative to the constraints CT.

In a module D30, a reliability value S is calculated by a function F from the envisaged monitoring control CCE and the constraints CT. In this particular embodiment, the function F also takes the error Err as input to the calculation of the value S.

From this reliability value S, a module D40 generates a safety control CS.

This safety control C as well as the envisaged monitoring control CCE are then used by a module D50. This module generates, from these controls (CS and CCE), a monitoring control CC, and applies it to the target system SC.

In this embodiment, the new state reached by the target system SC following the application of the monitoring control CC is measured by the module D1, which corresponds to the beginning of a new iteration in the monitoring loop implemented by the device DO.

FIG. 6 represents one embodiment in which the monitoring and generation methods as described above are set up in a vehicle D200 including a control apparatus EC and a computer EI.

The equipment EC can be connected to or integrated into a target system to be monitored. This equipment EC includes a device D0 for monitoring this target system in accordance with one mode of implementation of the invention.

This device D0 integrates a function F generated in the computer EI by a device D100 for generating the function F in accordance with one mode of implementation of the invention.

In this embodiment, the mode of implementation of the method for generating the function F comprises a simulation, in a step E101A, of a reference system SR similar to the target system SC, so as to carry out reference scenarios SCR for the generation of the function F.

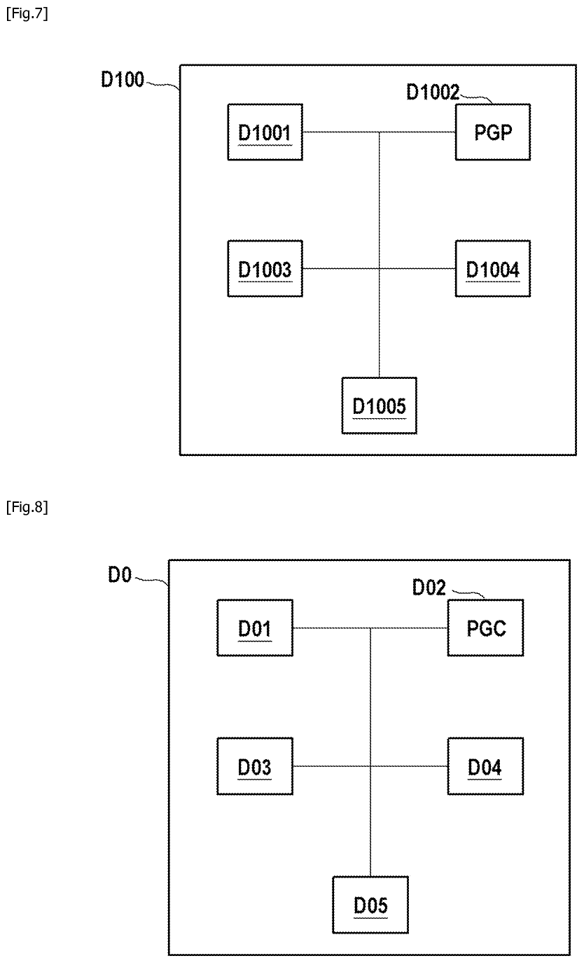

FIG. 7 represents the hardware architecture of a generation device D100 in accordance with one particular embodiment of the invention.

In the embodiment described here, the preparation device D100 has hardware architecture of a computer. It comprises in particular a processor D1001, a read-only memory D1002, a random-access memory D1003, a rewritable non-volatile memory D1004 and communication means D1005.

The read-only memory D1002 of the device D100 constitutes a recording medium in accordance with the invention, readable by the processor D1001 and on which a computer program PGP in accordance with the invention is recorded, this program including instructions for the execution of the steps of a generation method according to the invention described previously with reference to FIG. 1 in one embodiment.

The computer program PGP defines functional modules of the determination device D100 represented in FIG. 2.

FIG. 8 represents the hardware architecture of a monitoring device D0 in accordance with one particular embodiment of the invention.

In the embodiment described here, the monitoring device D0 has a hardware architecture of a control apparatus. It comprises in particular a processor D01, a read-only memory D02, a random-access memory D03, a rewritable non-volatile memory D04 and communication means D05.

The read-only memory D02 of the device D0 constitutes a recording medium in accordance with the invention, readable by the processor D01 and on which a computer program PGC in accordance with the invention is recorded, this program including instructions for the execution of the steps of a monitoring method according to the invention described previously with reference to FIG. 3.

The computer program PGC defines functional modules of the monitoring device D0 represented in FIG. 5.

1. A method comprising:
monitoring a target system wherein said monitoring comprises:
obtaining input data relating to at least one current state of the target system,
obtaining at least one functioning constraint of the target system,
calculating, by a predictive control, an envisaged sequence of controls for monitoring the target system, from said input data, at least one target state of said target system, and said constraint;
calculating, by a function readable by electronic equipment, a reliability value of said envisaged sequence of monitoring controls, according to at least one safety criterion, from said envisaged sequence of monitoring controls, and said at least one constraint;
generating, from said reliability value and a safety policy, at least one safety control;
generating a monitoring control from said envisaged sequence of monitoring controls and said safety control, and applying this monitoring control to the target system.

2. The monitoring method according to claim 1, wherein said function belongs to at least one of the following categories:
an artificial neural network,
an implementation of a machine learning model,
an expert system.

3. The monitoring method according to claim 1, wherein said function is trained according to a reinforcement learning algorithm.

4. The monitoring method according to claim 1, including a step of updating said function.

5. The monitoring method according to claim 1, wherein said at least one safety control is a control to:
stop or not the functioning of said target system,
generate a data intended to improve a subsequent occurrence of the calculation step by said predictive control, by using this safety control as input to the predictive control, or
generate a data intended to improve a subsequent occurrence of the step of generating at least one safety control, by taking into account this data in the application of said safety policy.

6. The monitoring method according to claim 1, wherein the step of generating the at least one safety control includes the sub-steps of:
counting a number of safety controls previously generated and indicating a danger,
comparing this number with an additional threshold defined by the safety policy,
and the safety control is an emergency shutdown control to shutdown the target system if the additional threshold is exceeded.

7. The monitoring method according to claim 1, wherein said calculation, by said function of said reliability value takes as input at least one data previously calculated by said function.

8. A method for generating a function readable by electronic equipment and intended to calculate a reliability value of at least one envisaged sequence of controls for monitoring a target system, calculated by the predictive control, the method including the steps of:
obtaining at least one reference scenario associated with a reference system, said reference scenario including:
(i) at least one functioning constraint of the reference system,
(ii) at least one envisaged sequence of monitoring controls calculated by the predictive control from data relating to at least one state of the reference system, said at least one constraint and at least one target state of the reference system;
(iii) at least one target value characterizing a reliability of said at least one envisaged sequence of controls for monitoring this reference scenario;
determining parameter values of said function to minimize at least one error between said at least one target value of the at least one reference scenario and at least one value calculated by said function from said at least one envisaged sequence of monitoring controls and said at least one constraint of this at least one reference scenario
recording, on a medium readable by electronic equipment, said function taking the parameter values obtained during the determination step.

9. The generation method according to claim 8 wherein said at least one reference scenario is simulated by computer.

10. The monitoring method wherein said function is determined according to claim 8.

11. A monitoring device for monitoring a target system, said monitoring device including:
at least one processor; and
at least one non-transitory computer readable medium comprising instructions stored thereon which when executed by the at least one processor configure the monitoring device to:
obtain input data relating to at least one current state of the target system,
obtain at least one functioning constraint of the target system,
calculate by predictive control, an envisaged sequence of controls for monitoring the target system, from said input data, at least one target state of said target system, and said constraint;
calculate by a function readable by electronic equipment, a reliability value of said envisaged sequence of monitoring controls-, according to at least one safety criterion, from said envisaged sequence of monitoring controls, and said at least one constraint;
generate from said reliability value and a safety policy, at least one safety control;
generate a monitoring control from said envisaged sequence of monitoring controls and said safety control, and for applying this monitoring control to the target system.

12. A generating device for generating a function readable by electronic equipment and intended to calculate a reliability value of at least one envisaged sequence of controls for monitoring a target system, calculated by a predictive control, the generating device including at least one processor; and
at least one non-transitory computer readable medium comprising instructions stored thereon which when executed by the at least one processor configure the generating device to:
obtain at least one reference scenario associated with a reference system, said reference scenario including:
at least one functioning constraint of the reference system,
at least one envisaged sequence of monitoring controls calculated by the predictive control from data relating to at least one state of the reference system, said at least one constraint and at least one target state of the reference system;
at least one target value characterizing a reliability of said at least one envisaged sequence of monitoring controls of this reference scenario;
determine parameter values of said function to minimize at least one error between said at least one target value of the at least one reference scenario and at least one value calculated by said function from said at least one envisaged sequence of monitoring controls and said at least one constraint of this at least one reference scenario
record, on a medium readable by electronic equipment, said function taking the parameter values obtained by the determination module.

13. A system comprising:
a control apparatus including at least one monitoring device, said monitoring device including:
at least one processor; and
at least one non-transitory computer readable medium comprising instructions stored thereon which when executed by the at least one processor configure the monitoring device to:
obtain input data relating to at least one current state of the target system,
obtain at least one functioning constraint of the target system,
calculate by predictive control, an envisaged sequence of controls for monitoring the target system, from said input data, at least one target state of said target system, and said constraint;
calculate by a function readable by electronic equipment, a reliability value of said envisaged sequence of monitoring controls, according to at least one safety criterion, from said envisaged sequence of monitoring controls, and said at least one constraint;
generate from said reliability value and a safety policy, at least one safety control;
generate a monitoring control from said envisaged sequence of monitoring controls and said safety control, and for applying this monitoring control to the target system; and
the system further comprising:
computing equipment including a generation device according to claim 12.

14. (canceled)

15. (canceled)

16. A non-transitory computer readable medium having stored thereon instructions which, when executed by a processor, cause the processor to implement the method of claim 1.
